(19) United States
(12) Patent Application Publication
(10) Pub. No.: US 2022/0263321 A1
(43) Pub. Date: Aug. 18, 2022

(54) PHOTOVOLTAIC CONTROL APPARATUS AND METHOD, AND SYSTEM

(71) Applicant: Huawei Digital Power Technologies Co., Ltd., Shenzhen (CN)

(72) Inventors: Yanzhong ZHANG, Shanghai (CN); Zhenhuan SHU, Shanghai (CN); Xun WANG, Shanghai (CN)

(21) Appl. No.: 17/738,379

(22) Filed: May 6, 2022

Related U.S. Application Data
(63) Continuation of application No. PCT/CN2020/113097, filed on Sep. 2, 2020.

(30) Foreign Application Priority Data
Nov. 8, 2019 (CN) 201911089818.4

(51) Int. Cl. H02J 3/46; H02J 3/38

(52) U.S. Cl. CPC H02J 3/46; H02J 2300/26; H02J 3/381

(57) ABSTRACT

A photovoltaic control apparatus and method, and a system, and relates to the field of photovoltaic power generation technologies, to reduce the system costs. The apparatus is applied to a photovoltaic system including a plurality of strings. The apparatus includes a control circuit, a first path circuit, a second path circuit, and an inverter circuit. The control circuit is configured to control a direct current signal of at least one first string in the plurality of strings to be transmitted by using the first path circuit. The first path circuit is configured to perform MPPT processing on the direct current signal of the first string. The control circuit is further configured to control a direct current signal of at least one second string in the plurality of strings to be transmitted by using the second path circuit.

### CROSS-REFERENCE TO RELATED APPLICATIONS

This application is a continuation of International Application No. PCT/CN2020/113097, filed on Sep. 2, 2020, which claims priority to Chinese Patent Application No. 201911089818.4, filed on Nov. 8, 2019. The disclosures of the aforementioned applications are hereby incorporated by reference in their entireties.

### TECHNICAL FIELD

This application relates to the field of photovoltaic power generation technologies, and in particular, to a photovoltaic control apparatus and method, and a system.

### BACKGROUND

A photovoltaic system is a power generation system that directly converts solar energy into electric energy by using a photovoltaic component. As shown in FIG. 1, the system may include a plurality of strings, a photovoltaic controller, and a power grid. Each string may include a plurality of photovoltaic components. Herein, FIG. 1 shows n strings, where each string includes m photovoltaic components that are connected in series. As shown in FIG. 2, a string 1, a string 2, and a string 3 are used as an example. When some photovoltaic components in the string 3 are blocked, a maximum power point P3 of the string 3 is lower than a maximum power point P1 of the string 1 and a maximum power point P2 of the string 2. In this case, a maximum power point voltage of the string 3 is lower than a maximum power point voltage of the string 1 and a maximum power point voltage of the string 2; and therefore, maximum power point voltages of the plurality of strings in the system are inconsistent.

In the conventional technology, as shown in FIG. 3, a group of maximum power point tracking (MPPT) modules are disposed in the photovoltaic controller. Every two strings are connected to one MPPT module. Maximum power point tracking and voltage step-up processing are performed on the two strings by using the MPPT module, so that a maximum power point voltage of a blocked string is greater than a minimum voltage of an inverter circuit in the photovoltaic controller, to resolve a problem that the maximum power point voltages of the plurality of strings are inconsistent. However, in this solution, a power of each MPPT module needs to meet a maximum power requirement of a string. A power sum of the group of MPPT modules is greater than a power of the inverter circuit. In addition, when the string is not blocked, the maximum power point voltage of the string exceeds the minimum voltage required for the inverter circuit. In this case, the MPPT module is in an idle state. Therefore, the MPPT module in this solution has low utilization and high costs.

### SUMMARY

This application provides a photovoltaic control apparatus and method, and a system, to reduce the costs of a photovoltaic system.

To achieve the foregoing objective, the following technical solutions are used in this application.

According to a first aspect, a photovoltaic control apparatus is provided. The photovoltaic control apparatus is applied to a photovoltaic system including a plurality of strings. The apparatus includes a control circuit, a first path circuit, a second path circuit, and an inverter circuit. The control circuit is configured to control a direct current signal of at least one first string in the plurality of strings to be transmitted by using the first path circuit. The first path circuit is configured to perform maximum power point tracking (MPPT) processing on the direct current signal of the first string. The control circuit is further configured to control a direct current signal of at least one second string in the plurality of strings to be transmitted by using the second path circuit. The inverter circuit is configured to convert the direct current signal of the second string or the processed direct current signal of the first string into an alternating current signal.

According to a second aspect, a photovoltaic control apparatus is provided. The photovoltaic control apparatus is applied to a photovoltaic system including a plurality of strings. The apparatus includes a control circuit, a first path circuit, and a second path circuit. The apparatus is connected to an inverter circuit. The control circuit is configured to control a direct current signal of at least one first string in the plurality of strings to be transmitted by using the first path circuit. The first path circuit is configured to perform maximum power point tracking (MPPT) processing on the direct current signal of the first string. The control circuit is further configured to control a direct current signal of at least one second string in the plurality of strings to be transmitted by using the second path circuit. In this way, the inverter circuit can convert the direct current signal of the second string or the processed direct current signal of the first string into an alternating current signal.

In the technical solutions provided in the first aspect and the second aspect, the control circuit may transmit direct current signals of the plurality of strings to the inverter circuit by separately using the first path circuit and the second path circuit. Only the first path circuit performs the MPPT processing on the direct current signal of the string. The MPPT processing is not performed on the direct current signals of all the strings, thereby reducing the costs of a photovoltaic system.

In an embodiment, the first string indicates a string whose maximum power point voltage of a corresponding direct current signal is less than a first preset voltage in the plurality of strings. In the foregoing possible implementation, the first path circuit may perform the MPPT processing on the direct current signal of the string whose maximum power point voltage is less than the first preset voltage, to ensure that the maximum power point voltage of the direct current signal of the string meets a requirement of the inverter circuit, thereby improving conversion efficiency of the inverter circuit.

In an embodiment, the first string further indicates a string whose current-voltage curve is to be detected in the plurality of strings. In the foregoing possible implementation, the first path circuit may perform the MPPT processing on the direct current signal of the string whose current-voltage curve is to be detected, to reduce a power during the MPPT processing.

In an embodiment, the first path circuit includes a first switch circuit and an MPPT circuit, the first switch circuit includes a plurality of first switches, the second path circuit includes a plurality of second switches, each first switch corresponds to one or more first strings and corresponds to one or more second strings, and each second switch corresponds to one or more second strings and corresponds to one or more first strings. In the foregoing possible implementation, a design of controlling transmission paths of the direct current signals of the plurality of strings by using the plurality of first switches and the plurality of second switches is simple and easy to implement.

In an embodiment, the control circuit is specifically configured to: control the first switch that is in the first switch circuit and that corresponds to the first string, to be in a closed state, and control the second switch that is in the second path circuit and that corresponds to the first string, to be in an open state, to control the direct current signal of the first string to be transmitted by using the first path circuit; and control the first switch that is in the first switch circuit and that corresponds to the second string, to be in the open state, and control the second switch that is in the second path circuit and that corresponds to the second string, to be in the closed state, to control the direct current signal of the second string to be transmitted by using the second path circuit. In the foregoing possible implementation, a simple and effective manner of controlling the transmission paths of the direct current signals of the plurality of strings is provided.

In an embodiment, the MPPT circuit includes at least one MPPT sub-circuit, and each MPPT sub-circuit corresponds to one or more first strings. In the foregoing possible implementation, the plurality of first strings may share one MPPT sub-circuit, to improve utilization of the MPPT sub-circuit, that is, improve utilization of the MPPT circuit, thereby reducing the costs and improving an electric energy yield.

In an embodiment, at least two first strings in the plurality of strings share one MPPT sub-circuit, and the control circuit is further configured to: when a power of the MPPT sub-circuit reaches a maximum limited power, control direct current signals of some or all of the first strings that share the MPPT sub-circuit, to be transmitted by using the second path circuit switched from the first path circuit. In the foregoing possible implementation, because the power of the shared MPPT sub-circuit reaches the maximum limited power, if the MPPT sub-circuit is continuously shared, the MPPT sub-circuit is damaged due to overload work. The direct current signals of the some or all of the first strings that share the MPPT sub-circuit are transmitted by using the second path circuit switched from the first path circuit, to reduce the power of the MPPT sub-circuit, thereby avoiding the damage to the MPPT sub-circuit and prolonging a service life of the MPPT sub-circuit.

In an embodiment, the control circuit is further configured to: when the maximum power point voltage of the direct current signal of the at least one first string is greater than or equal to a second preset voltage, control the direct current signal of the first string whose maximum power point voltage is greater than or equal to the second preset voltage, to be transmitted by using the second path circuit switched from the first path circuit, where the second preset voltage is greater than the first preset voltage. In the foregoing possible implementation, because the MPPT processing no longer needs to be performed on the direct current signal of the first string whose maximum power point voltage is greater than or equal to the second preset voltage, the direct current signal of the first string whose maximum power point voltage is greater than or equal to the second preset voltage is transmitted by using the second path circuit switched from the first path circuit. In this way, the MPPT sub-circuit corresponding to the first string whose maximum power point voltage is greater than or equal to the second preset voltage can process the direct current signal that is of the first string and that requires the MPPT processing, to avoid a case in which the MPPT sub-circuit is in an idle state, thereby improving utilization of the MPPT circuit.

According to a third aspect, a photovoltaic control method is provided. The method is applied to a photovoltaic system including a plurality of strings and a photovoltaic control apparatus. The photovoltaic control apparatus includes a control circuit, a first path circuit, a second path circuit, and an inverter circuit (alternatively, the inverter circuit may be independently disposed and not integrated into the photovoltaic control apparatus). The method includes: The control circuit controls a direct current signal of at least one first string in the plurality of strings to be transmitted by using the first path circuit. The first path circuit performs maximum power point tracking (MPPT) processing on the direct current signal of the first string. The control circuit controls a direct current signal of at least one second string in the plurality of strings to be transmitted by using the second path circuit. The inverter circuit converts the direct current signal of the second string or the processed direct current signal of the first string into an alternating current signal.

In an embodiment, the first string indicates a string whose maximum power point voltage of a corresponding direct current signal is less than a first preset voltage in the plurality of strings.

In an embodiment, the first string further indicates a string whose current-voltage curve is to be detected in the plurality of strings.

In an embodiment, the first path circuit includes a first switch circuit and an MPPT circuit, the second path circuit includes the second path circuit, the first switch circuit includes a plurality of first switches, the second path circuit includes a plurality of second switches, each first switch corresponds to one or more first strings and corresponds to one or more second strings, and each second switch corresponds to one or more second strings and corresponds to one or more first strings.

In an embodiment, that the control circuit controls the direct current signal of the at least one first string in the plurality of strings to be transmitted by using the first path circuit includes: controlling the first switch that is in the first switch circuit and that corresponds to the first string, to be in a closed state, and controlling the second switch that is in the second path circuit and that corresponds to the first string, to be in an open state, to control the direct current signal of the first string to be transmitted by using the first path circuit. That the control circuit controls the direct current signal of the second string in the plurality of strings to be transmitted by using the second path circuit includes: controlling the first switch that is in the first switch circuit and that corresponds to the second string, to be in the open state, and controlling the second switch that is in the second path circuit and that corresponds to the second string, to be in the closed state, to control the direct current signal of the second string to be transmitted by using the second path circuit.

In an embodiment, the MPPT circuit includes at least one MPPT sub-circuit, and each MPPT sub-circuit corresponds to one or more first strings.

In an embodiment, at least two first strings in the plurality of strings share one MPPT sub-circuit, and the method further includes: when a power of the MPPT sub-circuit reaches a maximum limited power, controlling direct current signals of some or all of the first strings that share the MPPT sub-circuit, to be transmitted by using the second path circuit switched from the first path circuit.

In an embodiment, the method further includes: when the maximum power point voltage of the direct current signal of the at least one first string is greater than or equal to a second preset voltage, controlling the direct current signal of the first string whose maximum power point voltage is greater than or equal to the second preset voltage, to be transmitted by using the second path circuit switched from the first path circuit, where the second preset voltage is greater than the first preset voltage.

According to a fourth aspect, a photovoltaic system is provided. The photovoltaic system includes a plurality of strings, a photovoltaic controller, and a power grid. The photovoltaic controller is a photovoltaic control apparatus provided in the first aspect, the second aspect, or any one of possible implementations of the first aspect or the second aspect.

It may be understood that any photovoltaic control method or system provided above includes the photovoltaic control apparatus provided above. Therefore, for beneficial effects that can be achieved by the photovoltaic control method or system, refer to beneficial effects of the photovoltaic control apparatus provided above. Details are not described herein again.

### BRIEF DESCRIPTION OF DRAWINGS

FIG. 1 is a schematic diagram of a structure of a photovoltaic system;

FIG. 2 is a schematic diagram in which some components in a string are blocked;

FIG. 3 is a schematic diagram of a structure of a photovoltaic controller provided in the conventional technology;

FIG. 4 is a schematic diagram of a structure of a photovoltaic control apparatus according to an embodiment of this application;

FIG. 5 is a schematic diagram of a structure of another photovoltaic control apparatus according to an embodiment of this application;

FIG. 6 is a schematic diagram of a structure of still another photovoltaic control apparatus according to an embodiment of this application; and

FIG. 7 is a schematic flowchart of a photovoltaic control method according to an embodiment of this application.

### DESCRIPTION OF EMBODIMENTS

In this application, “at least one” means one or more, and “a plurality of” means two or more. The term “and/or” describes an association relationship for describing associated objects and represents that three relationships may exist. For example, A and/or B may represent the following cases: Only A exists, both A and B exist, and only B exists, where A and B may be singular or plural. The character “/” generally indicates an “or” relationship between the associated objects. “At least one of the following items (pieces)” or a similar expression thereof means any combination of these items, including any combination of singular items (pieces) or plural items (pieces). For example, at least one (piece) of a, b, or c may represent a, b, c, a and b, a and c, b and c, or a, b, and c, where a, b, and c may be in a singular or plural form. In addition, in the embodiments of this application, terms such as “first” and “second” are used to distinguish between same objects or similar objects whose functions and purposes are basically the same. For example, a first string and a second string are merely intended to distinguish between different strings, and are not intended to limit a sequence thereof. A person skilled in the art may understand that the terms such as “first” and “second” do not constitute a limitation on a quantity or an execution sequence.

It should be noted that, in this application, the term such as “example” or “for example” is used to represent giving an example, an illustration, or descriptions. Any embodiment or design described as an “example” or “for example” in this application should not be explained as being more preferred or having more advantages than another embodiment or design. Exactly, use of the word “example”, “for example”, or the like is intended to present a related concept in a specific manner.

The technical solutions of this application may be applied to a photovoltaic system. The photovoltaic system may indicate a power generation system that directly converts solar energy into electric energy by using a photovoltaic component. The photovoltaic system may also be referred to as a photovoltaic power generation system or a solar photovoltaic system. The photovoltaic system may have a plurality of different structure forms. For example, the photovoltaic system may include a battery, or may not include a battery. The photovoltaic system without the battery may be referred to as a non-schedulable photovoltaic system. In this system, an inverter circuit configured to implement grid connection may convert the direct current electric energy generated by the photovoltaic component into alternating current electric energy with the same frequency and the same phase as a power grid voltage. The photovoltaic system with the battery may be referred to as a schedulable photovoltaic system. The system has a function of a relentless power supply. In the system, direct current electric energy generated by a photovoltaic string may be inverted by the inverter circuit and then transmitted to a power grid, or may charge the battery after DC-DC conversion.

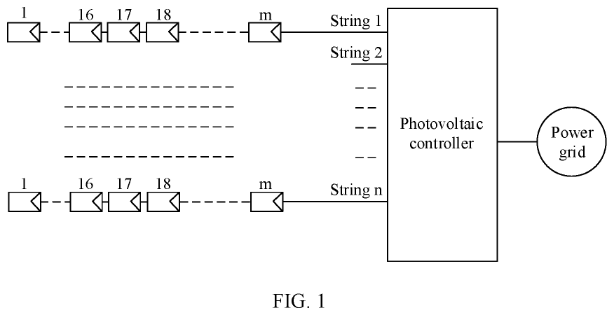

FIG. 1 is a schematic diagram of a structure of a photovoltaic system according to an embodiment of this application. With reference to FIG. 1, the photovoltaic system may include a plurality of strings, a photovoltaic controller, and a power grid. The photovoltaic controller may indicate an automatic control device configured to control a working status of the entire system. The photovoltaic controller may include an inverter circuit configured to perform direct current-alternating current conversion.

In the system, each string may include a plurality of photovoltaic components that are connected in series and/or in parallel. The photovoltaic component may be a solar cell component (also referred to as a PV component). A single solar cell is a smallest unit that converts photon energy into electric energy. The solar cell component is a smallest unit used when a plurality of single solar cells are classified based on electric performance and then the solar cells are connected in series and in parallel and encapsulated and combined to form a battery for use. The solar cell components may form a string in a serial connection manner and/or a parallel connection manner. In the serial connection manner, an output voltage may be proportionally increased without a change of an output current. In the parallel connection manner, an output current may be proportionally increased without a change of an output voltage. In a manner of combining the serial connection manner and the parallel connection manner, the output voltage and the output current can be both increased.

For each string in the photovoltaic string, at specific illuminance and a specific ambient temperature, the string may work at different output voltages. In other words, the output power of the string varies with the illuminance, the ambient temperature, and the output voltage. However, at specific illuminance and a specific ambient temperature, there is only one maximum power point (MPP). Maximum power point tracking (MPPT) is to constantly adjust a working point of the string based on different external features such as the illuminance and the ambient temperature, so that the string constantly works at a maximum power point, that is, the string constantly outputs a maximum power. A maximum power point voltage may be an output voltage that is of the string and that corresponds to the maximum power point.

In actual application, due to factors such as inconsistent electrical parameters of components in each string and partial blocking or damage on some strings, maximum power points of a plurality of strings and maximum power point voltages of the plurality of strings may be inconsistent. Therefore, an output power of the system is reduced. This may be also referred to as a “mismatch loss”. This affects an electric energy yield of a power station in various degrees. On this basis, the embodiments of this application provide a photovoltaic control apparatus and method, and a system, to resolve the “mismatch loss” problem, thereby improving the electric energy yield of the power station.

FIG. 4 is a schematic diagram of a structure of a photovoltaic control apparatus according to this application. The apparatus may serve as a photovoltaic controller applied in the photovoltaic system shown in FIG. 1. The apparatus may include a control circuit 101, a first path circuit 102, a second path circuit 103, and an inverter circuit 104. A plurality of strings are connected to the inverter circuit 104 by separately using the first path circuit 102 and the second path circuit. The control circuit 101 is separately connected to the plurality of strings, the first path circuit 102, the second path circuit 103, and the inverter circuit 104. Alternatively, the inverter circuit 104 may be disposed independently and is not integrated into the photovoltaic control apparatus. The photovoltaic control apparatus is connected to the inverter circuit 104.

In this embodiment of this application, the control circuit 101 is configured to control a direct current signal of at least one first string in the plurality of strings to be transmitted by using the first path circuit 102. The first path circuit 102 is configured to perform MPPT processing on the direct current signal of the first string. The control circuit 101 is further configured to control a direct current signal of at least one second string in the plurality of strings to be transmitted by using the second path circuit 103. The inverter circuit 104 is configured to convert the direct current signal of the second string or the processed direct current signal of the at least one first string into an alternating current signal. In other words, the inverter circuit 104 is specifically configured to: convert the direct current signal of the second string into the alternating current signal, or convert the processed direct current signal of the first string into the alternating current signal, or convert the direct current signal of the second string and the processed direct current signal of the first string into the alternating current signals.

The MPPT processing may indicate a series of processing such as tracking a maximum power point of a direct current signal of a string and performing voltage step-up or voltage step-down on a maximum power point voltage. The operation of tracking the maximum power point of the direct current signal of the string is not affected by another string and does not affect another string. The at least one first string includes one or more first strings. The first string may indicate a string that requires the MPPT processing in the plurality of strings. The at least one second string includes one or more second strings. The second string may indicate a string that does not require the MPPT processing in the plurality of strings.

In an embodiment, the first string indicates a string whose maximum power point voltage of a corresponding direct current signal is less than a first preset voltage in the plurality of strings. Further, the first string further indicates a string whose current-voltage (IV) curve is to be detected in the plurality of strings, and the like. The first preset voltage herein may be preset. For example, the first preset voltage may be equal to a minimum working voltage of the inverter circuit 104. The at least one second string may include a string whose maximum power point voltage of a corresponding direct current signal is greater than or equal to the first preset voltage in the plurality of strings, a string whose current-voltage (IV) curve does not need to be detected, and the like. The control circuit 101 may learn of a maximum power point voltage of each of the plurality of strings. The maximum power point voltage of each string is compared with the first preset voltage, to determine the string whose maximum power point voltage is less than the first preset voltage. The control circuit 101 may determine, based on a communication instruction of a host computer or a scanning algorithm of the control circuit 101, the string whose IV curve is to be detected. The IV curve of the string herein may indicate a relationship between an output current and an output voltage of the string after being illuminated.

In addition, there are two optional paths for transmitting the direct current signal of each of the plurality of strings from the string to the inverter circuit 104. A first path is the string->the first path circuit 102->the inverter circuit 104. A second path is the string->the second path circuit 103->the inverter circuit 104. The first path circuit 102 has an MPPT processing function, and the second path circuit 103 does not have the MPPT processing function. Therefore, the control circuit 101 may be configured to control, based on whether the MPPT processing needs to be performed on the direct current signal of each string, the direct current signal of the string to be transmitted by using the first path or the second path.

Specifically, for each of the plurality of strings, if the MPPT processing needs to be performed on the direct current signal of the string, the string is the first string. The control circuit 101 controls the direct current signal of the string to be transmitted by using the first path, so that the first path circuit 102 performs the MPPT processing on the direct current signal of the string. Then, the first path circuit 102 transmits the processed direct current signal of the string to the inverter circuit 104. If the MPPT processing does not need to be performed on the direct current signal of the string, the string is the second string. The control circuit 101 controls the direct current signal of the string to be transmitted by using the second path, so that the second path circuit 103 transmits the direct current signal of the string to the inverter circuit 104. After the inverter circuit 104 receives the direct current signal of the second string and/or the processed direct current signal of the first string, the inverter circuit 104 converts the received signal into an alternating current signal. The alternating current signal may be input into a power grid, or is configured to supply power for an alternating current load.

That the first path circuit 102 performs the MPPT processing on the direct current signal of the string specifically includes: When the string is a string whose maximum power point voltage of a corresponding direct current signal is less than the first preset voltage, the first path circuit 102 may perform voltage step-up on the maximum power point voltage of the direct current signal of the string, so that the voltage is greater than or equal to the first preset voltage, thereby ensuring that the maximum power point voltage after the voltage step-up can meet a requirement on a minimum working voltage for the inverter circuit 104. When the string is a string whose IV curve is to be detected, the first path circuit 102 may detect a change relationship between the voltage and the current of the string, and also determine the IV curve of the string. In addition, the first path circuit 102 may be further configured to perform maximum power point tracking on the direct current signal of the first string, and the inverter circuit 104 may be further configured to perform maximum power point tracking on the direct current signal of the second string.

In actual application, when the inverter circuit 104 converts a power grid voltage, a minimum voltage requirement (that is, a minimum working voltage) is imposed on an input direct current voltage. When the voltage is lower than the minimum working voltage, the inverter circuit 104 cannot work. Therefore, the inverter circuit 104 needs to perform voltage step-up on the maximum power point voltage of the direct current signal of the string that is lower than the minimum working voltage, and continuously track a lower maximum power point voltage. For example, the minimum working voltage required for the inverter circuit 104=the power grid voltage×1.414+30 V.

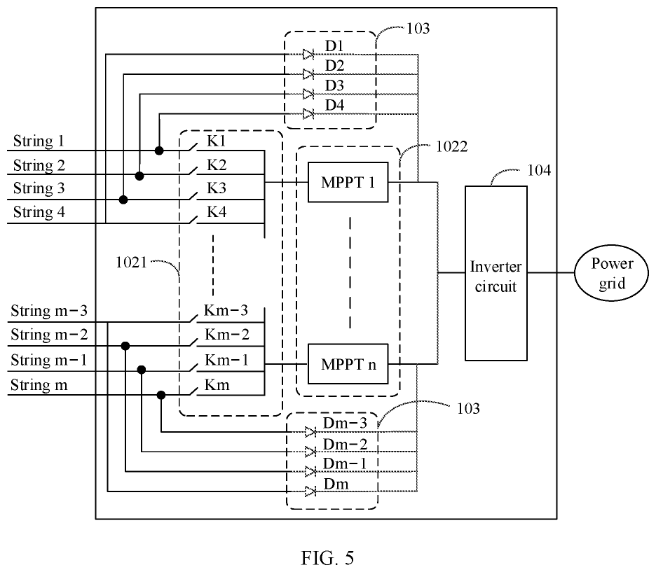

Further, as shown in FIG. 5, the first path circuit 102 includes a first switch circuit 1021 and an MPPT circuit 1022. The MPPT circuit 1022 is specifically configured to perform the operation of performing the MPPT processing on the direct current signal of the string. The first switch circuit 1021 includes a plurality of first switches. The second path circuit 103 includes a plurality of second switches. A one-to-one correspondence or a one-to-many correspondence exists between each of the plurality of strings, and each of the plurality of first switches or each of the plurality of second switches. FIG. 5 is described by using an example in which the one-to-one correspondence exists between each of the plurality of strings, and each of the plurality of first switches or each of the plurality of second switches. A string 1 to a string m indicate the plurality of strings, K1 to Km indicate the plurality of first switches included in the first switch circuit 1021, and D1 to Dm indicate the plurality of second switches included in the second path circuit 103. That the one-to-one correspondence or the one-to-many correspondence exists between each of the plurality of strings, and each of the plurality of first switches or each of the plurality of second switches may also be understood as that each first switch corresponds to one or more first strings and corresponds to one or more second strings, and each second switch corresponds to one or more second strings and corresponds to one or more first strings.

That the one-to-one correspondence exists between each of the plurality of first switches and each of the plurality of strings may indicate that one first switch is correspondingly disposed for one string. The first switch may be configured to enable or disable a first path corresponding to the string. That the one-to-many correspondence exists between each of the plurality of first switches and each of the plurality of strings may indicate that one first switch is correspondingly disposed for a plurality of strings. The first switch may be configured to enable or disable a first path corresponding to the plurality of strings. Likewise, that the one-to-one correspondence exists between each of the plurality of second switches and each of the plurality of strings may indicate that one second switch is correspondingly disposed for one string. The second switch may be configured to enable or disable a second path corresponding to the string. That the one-to-many correspondence exists between each of the plurality of second switches and each of the plurality of strings may indicate that one second switch is correspondingly disposed for a plurality of strings. The second switch may be configured to enable or disable a second path corresponding to the plurality of strings. In actual application, the one-to-one correspondence may exist between each of some strings in the plurality of strings, and each of the first switch and the second switch; and the one-to-many correspondence may exist between each of the other strings in the plurality of strings, and each of the first switch and the second switch. This is not specifically limited in this embodiment of this application.

In actual application, the first switch may be a mechanical switch device, a semiconductor switch device, or the like. The mechanical switch device may indicate a switch device for enabling and disabling one or more circuits through an operation of a separable contact, for example, a contactor or a relay. The semiconductor switch device may indicate a switch device for connecting and blocking a current of a circuit by using electric conduction controllability of the semiconductor, for example, a switch circuit designed based on a transistor or a field effect transistor. The second switch may be a diode, a mechanical switch device, a semiconductor switch, or the like. FIG. 5 is described by using an example in which the second switch is a diode. This does not constitute a limitation on this embodiment of this application. When the switch is a common switch such as a mechanical switch device, the switch may include a closed state and an open state (which may also be referred to as an unclosed state or an off state). When the switch is a semiconductor switch device or a diode, the switch may include an on state and an off state. The on state may correspond to the closed state of the common switch, and the off state may correspond to the open state of the common switch.

Correspondingly, that the control circuit 101 is configured to control the direct current signal of the at least one first string in the plurality of strings to be transmitted by using the first path circuit 102 may be specifically: controlling the first switch that is in the first switch circuit 1021 and that corresponds to the first string, to be in the closed state, and controlling the second switch that is in the second path circuit 103 and that corresponds to the first string, to be in the open state, to control the direct current signal of the first string to be transmitted by using the first path circuit 102. For example, in FIG. 5, the at least one first string includes a string 1 to a string 4. First switches corresponding to the string 1 to the string 4 are K1 to K4, and second switches corresponding to the string 1 to the string 4 are D1 to D4. In this case, the control circuit 101 may be configured to: control K1 to K4 to be in the closed state, and control D1 to D4 to be in the off state, to control direct current signals of the string 1 to the string 4 to be transmitted to the MPPT circuit 1022 by using the first switch circuit 1021, so that the MPPT circuit 1022 performs the MPPT processing on the direct current signals of the string 1 to the string 4 and then transmits the processed signals to the inverter circuit 104. FIG. 5 is described by using an example in which the first switch is a mechanical switch device and the second switch is a diode.

That the control circuit 101 is configured to control the direct current signal of the at least one second string in the plurality of strings to be transmitted by using the second path circuit 103 may be specifically: controlling the first switch that is in the first switch circuit 1021 and that corresponds to the second string, to be in the open state, and controlling the second switch that is in the second path circuit 103 and that corresponds to the second string, to be in the closed state, to control the direct current signal of the second string to be transmitted by using the second path circuit 103. For example, in FIG. 5, the at least one second string includes a string m−3 to a string m. First switches corresponding to the string m−3 to the string m are Km−3 to Km, and second switches corresponding to the string m−3 to the string m are Dm−3 to Dm. In this case, the control circuit 101 may be configured to: control K1 to K4 to be in the open state, and control D1 and D2 to be in the on state, to control direct current signals of the string m−3 to the string m to be transmitted to the inverter circuit 104 by using the second path circuit 103.

Further, as shown in FIG. 5, the MPPT circuit 1022 may include at least one MPPT sub-circuit. A one-to-one correspondence or a one-to-many correspondence may exist between the at least one MPPT sub-circuit and the at least one first string (that is, each MPPT sub-circuit may correspond to one or more first strings). Each MPPT sub-circuit may be configured to perform the MPPT processing. An MPPT 1 to an MPPT n indicate the at least one MPPT sub-circuit.

That the one-to-one correspondence exists between the at least one MPPT sub-circuit and the at least one first string may indicate that one MPPT sub-circuit is correspondingly disposed for one first string. The MPPT sub-circuit may be configured to perform the MPPT processing on the direct current signal of the first string. That the one-to-many correspondence exists between the at least one MPPT sub-circuit and the at least one first string may indicate that one MPPT sub-circuit is correspondingly disposed for a plurality of first strings. The MPPT sub-circuit may be configured to perform the MPPT processing on the direct current signals of the plurality of first strings.

In an embodiment, at least two first strings in the plurality of first strings share one MPPT sub-circuit. The control circuit 101 is further configured to: when a power of the shared MPPT sub-circuit reaches a maximum limited power, control direct current signals of some or all of the first strings that share the MPPT sub-circuit, to be transmitted by using the second path circuit 103 switched from the first path circuit 102.

The direct current signal of the string is affected by parameters such as illuminance and an ambient temperature. At different illuminance and different ambient temperatures, the direct current signal of the string has different maximum power points. When the illuminance and the ambient temperature change dynamically, the maximum power point of the direct current signal of the string also changes dynamically. When the MPPT processing is performed at different maximum power points, the power corresponding to the MPPT circuit changes dynamically. In other words, the power of the MPPT sub-circuit corresponding to the string also changes dynamically. The MPPT sub-circuit corresponding to the string indicates the MPPT sub-circuit that performs the MPPT processing on the direct current signal of the string.

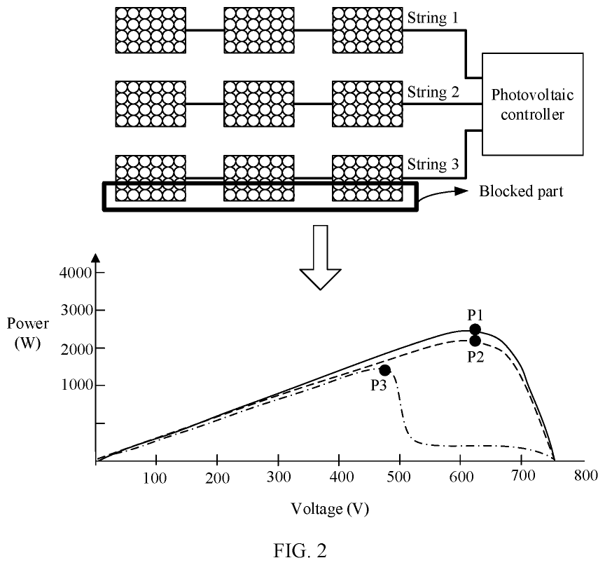

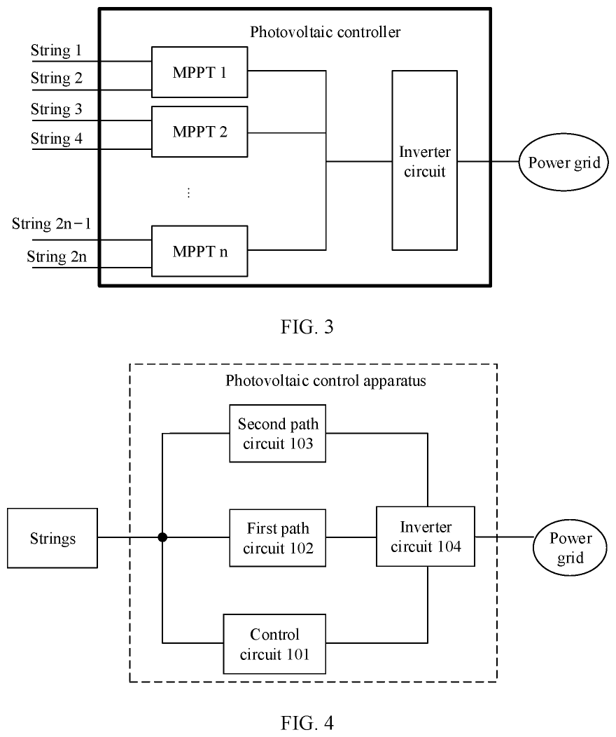

For example, the string 1, the string 2, and the string 3 shown in FIG. 2 are used as an example. The components of the string 1 and the string 2 are not blocked. Some components of the string 3 are blocked. The maximum power points of the direct current signals of the string 1 and the string 2 are respectively P1 and P2. The maximum power point of the direct current signal of the string 3 is P3. It may be learned from FIG. 2 that maximum power point voltages corresponding to P1 and P2 are about 630 V, and a maximum power point voltage corresponding to P3 is about 470 V. If the MPPT processing is to perform voltage step-up on the maximum power point voltage to 700 V, the power of the MPPT sub-circuit corresponding to the string 3 is greater than the powers of the MPPT sub-circuits corresponding to the string 1 and the string 2.

When at least two first strings in the plurality of first strings share one MPPT sub-circuit, and a power of the shared MPPT sub-circuit reaches a maximum limited power, if the MPPT sub-circuit is continuously shared, the MPPT sub-circuit is damaged due to overload work. The direct current signals of the some or all of the first strings that share the MPPT sub-circuit are transmitted by using the second path circuit switched from the first path circuit, to reduce the power of the MPPT sub-circuit, thereby avoiding the damage to the MPPT sub-circuit and prolonging a service life of the MPPT sub-circuit.

Specifically, the control circuit 101 may control a first switch that is in the first switch circuit 1021 and that corresponds to some or all of first strings that share the MPPT sub-circuit, to be in the open state; and control a second switch that is in the second path circuit 103 and that corresponds to some or all of first strings that share the MPPT sub-circuit, to be in the closed state (or the on state), to control the direct current signals of the some or all of the first strings that share the MPPT sub-circuit to be transmitted by using the second path circuit 103 switched from the first path circuit 102.

For example, if the string 1 and the string 2 correspond to the MPPT 1, the string 1 corresponds to the first switch D1 and the second switch K1, and the string 2 corresponds to the first switch D2 and the second switch K2. When the power of the MPPT 1 reaches the maximum limited power, the control circuit 101 may control K1 to be in the open state, and control D1 to be in the closed state, to control the direct current signal of the string 1 to be transmitted by using the second path circuit 103 switched from the first path circuit 102. Alternatively, the control circuit 101 may control both K1 and K2 to be in the open state, and control D1 and D2 to be in the closed state, to control the direct current signals of both the string 1 and the string 2 to be transmitted by using the second path circuit 103 switched from the first path circuit 102.

In an embodiment, the control circuit 101 may be further configured to: when the maximum power point voltage of the direct current signal of the at least one first string is greater than or equal to a second preset voltage, control the direct current signal of the first string whose maximum power point voltage is greater than or equal to the second preset voltage, to be transmitted by using the second path circuit 103 switched from the first path circuit 102, where the second preset voltage is greater than the first preset voltage. It should be noted that the second preset voltage herein may be preset. For example, the second preset voltage may be equal to a working voltage of the inverter circuit 104.

Because the maximum power point of the direct current signal of the string also changes dynamically with the parameters such as the illuminance and the ambient temperature, the maximum power point voltage also changes dynamically. When the maximum power point voltage of the direct current signal that is of the at least one first string in the strings and that is transmitted by using the first path circuit 102 increases gradually and is greater than or equal to the second preset voltage, the MPPT processing does not need to be performed on the direct current signal of the at least one first string, so that the control circuit 101 can control the direct current signal of the at least one first string to be transmitted by using the second path circuit 103. In this way, the MPPT sub-circuit corresponding to the at least one first string can process the direct current signals of the other strings, to avoid a case in which the MPPT sub-circuit is in the idle state, thereby improving utilization of the MPPT circuit and reducing the integration costs of the MPPT circuit.

Specifically, the control circuit 101 may control a first switch that is in the first switch circuit 1021 and that corresponds to the first string whose maximum power point voltage is greater than or equal to the second preset voltage, to be in the open state; and control a second switch that is in the second path circuit 103 and that corresponds to the first string whose maximum power point voltage is greater than or equal to the second preset voltage, to be in the closed state (or the on state), to control the direct current signal of the first string whose maximum power point voltage is greater than or equal to the second preset voltage, to be transmitted through the second path circuit 103 switched from the first path circuit 102.

For example, in FIG. 5, if the first string whose maximum power point voltage is greater than or equal to the second preset voltage includes the string 1 and the string 2, the string 1 corresponds to the first switch D1 and the second switch K1, and the string 2 corresponds to the first switch D2 and the second switch K2. In this case, the control circuit 101 may control K1 and K2 to be in the open state, and control D1 and D2 to be in the closed state, to control the direct current signals of the string 1 and the string 2 to be transmitted by using the second path circuit 103 switched from the first path circuit 102.

It should be noted that, when the system is started, the control circuit 101 may control the direct current signals of the plurality of strings to be transmitted by using the second path circuit 103. When the direct current signals of the plurality of strings change dynamically with the parameters such as the illuminance and the ambient temperature, a string that requires the MPPT processing is determined based on related parameters of direct current signals of different strings, to further implement control on transmission in the manner provided above. In a transmission process, the direct current signals of the plurality of strings may be all transmitted by using the second path circuit 103, or all transmitted by using the first path circuit 102. This is not specifically limited in this application.

In addition, in this embodiment of this application, the inverter circuit 104 further has an MPPT tracking function in addition to a direct current-alternating current conversion function. The inverter circuit 104 tracks maximum power points of all strings that are connected in parallel, rather than the maximum power point of the direct current signal of each string. This is different from the MPPT processing function of the MPPT circuit. In this way, when the maximum power point voltages of the direct current signals of the strings are inconsistent, a power loss occurs on some strings.

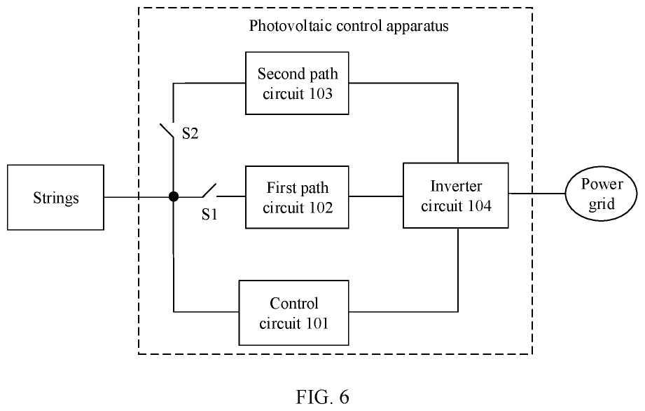

Further, with reference to FIG. 4 and FIG. 6, the apparatus may further include a third switch S1 and a fourth switch S2. The third switch S1 is located between the first path circuit 102 and each of the plurality of strings, and is configured to enable or disable a connection between the first path circuit 102 and each of the plurality of strings. The fourth switch S2 is located between the second path circuit 103 and each of the plurality of strings, and is configured to enable or disable a connection between the second path circuit 103 and each of the plurality of strings.

It should be noted that a specific implementation of the third switch and the fourth switch may be similar to the foregoing first switch and the foregoing second switch, for example, a mechanical switch or a semiconductor switch. Details are not described in this embodiment of this application.

The control circuit 101 may be configured to control the third switch and the fourth switch to be in the closed state or the open state. When the system works, if the direct current signals of the plurality of strings are all transmitted by using the first path circuit 102, the control circuit 101 may control the third switch to be in the closed state, and control the fourth switch to be in the open state. If the direct current signals of the plurality of strings are all transmitted by using the second path circuit 103, the control circuit 101 may control the third switch to be in the open state, and control the fourth switch to be in the closed state. If the direct current signals of the plurality of strings are separately transmitted by using the first path circuit 102 and the second path circuit 103, the control circuit 101 may control the third switch and the fourth switch to be both in the closed state. When the system does not work, the control circuit 101 may control both the third switch and the fourth switch to be in the open state.

The apparatus provided in this embodiment of this application may flexibly control the direct current signal that is of the string and that requires the MPPT processing, and transmit the direct current signal to the inverter circuit by using the first path circuit that can perform the MPPT processing; and control the direct current signal that is of the string and that does not require the MPPT processing, and transmit the direct current signal to the inverter circuit by using the second path circuit. In this way, it is ensured that the maximum power point voltages of the direct current signals of the plurality of strings can meet a requirement on the minimum working voltage for the inverter circuit, to improve utilization efficiency of the MPPT circuit. In addition, the MPPT circuit performs the operation of performing the voltage step-up processing on the maximum power point voltage and detecting the IV curve of the string. In comparison with the operation of performing the maximum power point tracking, the MPPT circuit has a lower power, to track an MPP at a low voltage and further reduce the power of the MPPT circuit. By using the apparatus, the plurality of strings may share one MPPT sub-circuit according to a requirement, to reduce the circuit costs and further improve an electric energy yield in comparison with a single-pole inverter.

An embodiment of this application further provides a photovoltaic system. The photovoltaic system includes a plurality of strings, a photovoltaic controller, and a power grid. The photovoltaic controller may be any photovoltaic control apparatus described in FIG. 4, FIG. 5, or FIG. 6 according to this embodiment of this application.

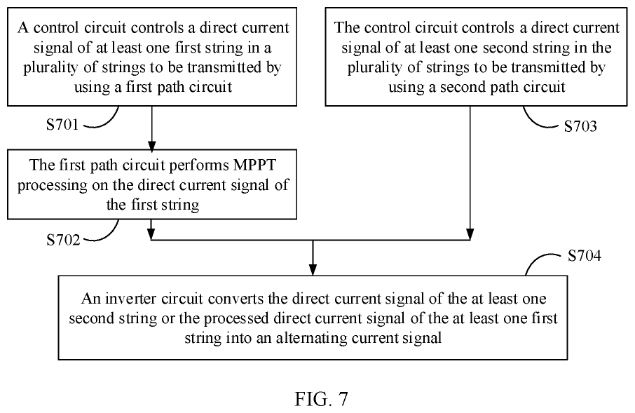

FIG. 7 is a schematic flowchart of a photovoltaic control method according to an embodiment of this application. The method is applied to a photovoltaic system including a plurality of strings and a photovoltaic control apparatus. The photovoltaic control apparatus may be any photovoltaic control apparatus provided above. With reference to FIG. 7, the method includes the following operations. Operation S701 and operation S702 may be performed in parallel to operation S703.

Operation S701. A control circuit controls a direct current signal of at least one first string in a plurality of strings to be transmitted by using a first path circuit.

Operation S702. The first path circuit performs MPPT processing on the direct current signal of the first string.

The at least one first string includes one or more first strings. The first string may indicate a string that requires the MPPT processing in the plurality of strings. In an embodiment, the first string may further indicate a string whose maximum power point voltage of a corresponding direct current signal is less than a first preset voltage in the plurality of strings, and/or a string whose current-voltage (IV) curve needs to be detected, and the like.

Operation S703. The control circuit controls a direct current signal of at least one second string in the plurality of strings to be transmitted by using a second path circuit.

The at least one second string includes one or more second strings. The second string may indicate a string that does not require the MPPT processing in the plurality of strings. In an embodiment, the second string may indicate a string whose maximum power point voltage of a corresponding direct current signal is greater than or equal to the first preset voltage in the plurality of strings. Further, the second string may further indicate a string whose current-voltage (IV) curve does not need to be detected, or the like.

Operation S704. An inverter circuit converts the direct current signal of the second string or the processed direct current signal of the first string into an alternating current signal. Specifically, the inverter circuit converts the direct current signal of the second string into the alternating current signal, or converts the processed direct current signal of the first string into the alternating current signal, or converts the direct current signal of the second string and the processed direct current signal of the first string into the alternating current signals.

In an embodiment, the first path circuit includes a first switch circuit and an MPPT circuit, the second path circuit includes the second path circuit, the first switch circuit includes a plurality of first switches, the second path circuit includes a plurality of second switches, each first switch corresponds to one or more first strings and corresponds to one or more second strings, and each second switch corresponds to one or more second strings and corresponds to one or more first strings. Correspondingly, operation S701 is specifically controlling the first switch that is in the first switch circuit and that corresponds to the first string, to be in a closed state, and controlling the second switch that is in the second path switch and that corresponds to the first string, to be in an open state, to control the direct current signal of the first string to be transmitted by using the first path circuit. Operation S702 is specifically controlling the first switch that is in the first switch circuit and that corresponds to the second string, to be in the open state, and controlling the second switch that is in the second path circuit and that corresponds to the second string, to be in the closed state, to control the direct current signal of the second string to be transmitted by using the second path circuit.

Further, the MPPT circuit includes at least one MPPT sub-circuit, and each MPPT sub-circuit may correspond to one or more first strings.

The direct current signal of the string is affected by parameters such as illuminance and an ambient temperature. At different illuminance and different ambient temperatures, the direct current signal of the string has different maximum power points. When the illuminance and the ambient temperature change dynamically, the maximum power point of the direct current signal of the string also changes dynamically. When the MPPT processing is performed at different maximum power points, the power corresponding to the MPPT circuit changes dynamically. In other words, the power of the MPPT sub-circuit corresponding to the string also changes dynamically. The MPPT sub-circuit corresponding to the string indicates the MPPT sub-circuit that performs the MPPT processing on the direct current signal of the string. Therefore, at least two first strings in the plurality of strings share one MPPT sub-circuit. The method may further include: when a power of the shared MPPT sub-circuit reaches a maximum limited power, controlling direct current signals of some or all of the first strings that share the MPPT sub-circuit, to be transmitted by using the second path circuit 103 switched from the first path circuit 102.

In addition, because the maximum power point of the direct current signal of the string also changes dynamically with the parameters such as the illuminance and the ambient temperature, the maximum power point voltage also changes dynamically. When the maximum power point voltage of the direct current signal that is of the at least one first string in the strings and that is transmitted by using the first path circuit 102 increases gradually and is greater than or equal to the second preset voltage, the MPPT processing does not need to be performed on the direct current signal of the at least one first string, so that the control circuit 101 can control the direct current signal of the at least one first string to be transmitted by using the second path circuit 103 switched from the first path circuit 102. In this way, the MPPT sub-circuit corresponding to the at least one first string can process the direct current signals of the other strings, to avoid a case in which the MPPT sub-circuit is in an idle state, thereby improving utilization of the MPPT circuit and reducing the integration costs of the MPPT circuit. Therefore, the method may further include: when the maximum power point voltage of the direct current signal of the at least one first string is greater than or equal to a second preset voltage, controlling the direct current signal of the first string whose maximum power point voltage is greater than or equal to the second preset voltage, to be transmitted by using the second path circuit 103 switched from the first path circuit 102, where the second preset voltage is greater than the first preset voltage.

It should be noted that, for specific descriptions of each operation in the method embodiments, reference may be correspondingly made to the descriptions of related components or circuits in the embodiments corresponding to the photovoltaic control apparatus. Details are not described in this embodiment of this application.

In the method provided in this embodiment of this application, the direct current signals of the plurality of strings may be flexibly controlled to be transmitted by using different paths. It can be ensured that the maximum power point voltages of the direct current signals of the plurality of strings can all meet the requirement on the minimum working voltage for the inverter circuit, to reduce the costs, improve utilization of the MPPT circuit, and improve an electric energy yield in comparison with a solution of a single-pole inverter.

Finally, it should be noted that the foregoing descriptions are merely specific implementations of the embodiments of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A photovoltaic control apparatus, comprising: a control circuit, a first path circuit, a second path circuit, and an inverter circuit; wherein
the control circuit is configured to control a direct current signal of at least one first string in the plurality of strings of a photovoltaic system to be transmitted by using the first path circuit;
the first path circuit is configured to perform maximum power point tracking (MPPT) processing on the direct current signal of the first string;
the control circuit is further configured to control a direct current signal of at least one second string in the plurality of strings to be transmitted by using the second path circuit; and
the inverter circuit is configured to convert the direct current signal of the second string or the processed direct current signal of the first string into an alternating current signal.

2. The apparatus according to claim 1, wherein the first string indicates a string whose maximum power point voltage of a corresponding direct current signal is less than a first preset voltage in the plurality of strings.

3. The apparatus according to claim 1, wherein the first string further indicates a string whose current-voltage curve is to be detected in the plurality of strings.

4. The apparatus according to claim 1, wherein the first path circuit comprises a first switch circuit and an MPPT circuit, and the first switch circuit comprises a plurality of first switches;
the second path circuit comprises a plurality of second switches; and
each first switch corresponds to one or more first strings and corresponds to one or more second strings, and each second switch corresponds to one or more second strings and corresponds to one or more first strings.

5. The apparatus according to claim 4, wherein the control circuit is configured to:
control the first switch that is in the first switch circuit and that corresponds to the first string, to be in a closed state, and control the second switch that is in the second path circuit and that corresponds to the first string, to be in an open state, to control the direct current signal of the first string to be transmitted by using the first path circuit; and
control the first switch that is in the first switch circuit and that corresponds to the second string, to be in the open state, and control the second switch that is in the second path circuit and that corresponds to the second string, to be in the closed state, to control the direct current signal of the second string to be transmitted by using the second path circuit.

6. The apparatus according to claim 4, wherein the MPPT circuit comprises at least one MPPT sub-circuit, and each MPPT sub-circuit corresponds to one or more first strings.

7. The apparatus according to claim 6, wherein at least two first strings in the plurality of strings share one MPPT sub-circuit, and the control circuit is further configured to:
when a power of the MPPT sub-circuit reaches a maximum limited power, control direct current signals of some or all of the first strings that share the MPPT sub-circuit, to be transmitted by using the second path circuit switched from the first path circuit.

8. The apparatus according to claim 1, wherein the control circuit is further configured to:
when a maximum power point voltage of the direct current signal of the first string is greater than or equal to a second preset voltage, control the direct current signal of the first string whose maximum power point voltage is greater than or equal to the second preset voltage, to be transmitted by using the second path circuit switched from the first path circuit, wherein the second preset voltage is greater than a first preset voltage.

9. A photovoltaic control method, comprising:
controlling, by a control circuit of a photovoltaic control apparatus, a direct current signal of at least one first string in a plurality of strings of a photovoltaic system to be transmitted by using a first path circuit of the photovoltaic control apparatus, wherein the photovoltaic system comprising the plurality of strings and the photovoltaic control apparatus, wherein the photovoltaic control apparatus comprises the control circuit, the first path circuit, a second path circuit, and an inverter circuit;
performing, by the first path circuit, maximum power point tracking (MPPT) processing on the direct current signal of the first string;
controlling, by the control circuit, a direct current signal of at least one second string in the plurality of strings to be transmitted by using the second path circuit; and
converting, by the inverter circuit, the direct current signal of the second string or the processed direct current signal of the first string into an alternating current signal.

10. The method according to claim 9, wherein the first string indicates a string whose maximum power point voltage corresponding to a corresponding direct current signal is less than a first preset voltage in the plurality of strings.

11. The method according to claim 9, wherein the first string further indicates a string whose current-voltage curve is to be detected in the plurality of strings.

12. The method according to claim 9, wherein the first path circuit comprises a first switch circuit and an MPPT circuit, the second path circuit comprises the second path circuit, the first switch circuit comprises a plurality of first switches, and the second path circuit comprises a plurality of second switches; and
each first switch corresponds to one or more first strings and corresponds to one or more second strings, and each second switch corresponds to one or more second strings and corresponds to one or more first strings.

13. The method according to claim 12, wherein the controlling, by the control circuit, a direct current signal of at least one first string in the plurality of strings to be transmitted by using the first path circuit comprises:
controlling the first switch that is in the first switch circuit and that corresponds to the first string, to be in a closed state, and controlling the second switch that is in the second path circuit and that corresponds to the first string, to be in an open state, to control the direct current signal of the first string to be transmitted by using the first path circuit; and
the controlling, by the control circuit, a direct current signal of at least one second string in the plurality of strings to be transmitted by using the second path circuit comprises:
controlling the first switch that is in the first switch circuit and that corresponds to the second string, to be in the open state, and controlling the second switch that is in the second path circuit and that corresponds to the second string, to be in the closed state, to control the direct current signal of the second string to be transmitted by using the second path circuit.

14. The method according to claim 12, wherein the MPPT circuit comprises at least one MPPT sub-circuit, and each MPPT sub-circuit corresponds to one or more first strings.

15. The method according to claim 14, further comprising:
when a power of a MPPT sub-circuit reaches a maximum limited power, controlling direct current signals of some or all of the first strings that share the MPPT sub-circuit, to be transmitted by using the second path circuit switched from the first path circuit, wherein at least two first strings in the plurality of strings share one MPPT sub-circuit.

16. The method according to claim 9, further comprising:
when a maximum power point voltage of the direct current signal of the first string is greater than or equal to a second preset voltage, controlling the direct current signal of the first string whose maximum power point voltage is greater than or equal to the second preset voltage, to be transmitted by using the second path circuit switched from the first path circuit, wherein the second preset voltage is greater than a first preset voltage.

17. A photovoltaic system, comprising:
a plurality of strings,
a power grid, and
a photovoltaic controller coupling the plurality of strings to the power grid, wherein the photovoltaic controller comprises a control circuit, a first path circuit, a second path circuit, and an inverter circuit, wherein
the control circuit is configured to control a direct current signal of at least one first string in the plurality of strings to be transmitted by using the first path circuit;
the first path circuit is configured to perform maximum power point tracking (MPPT) processing on the direct current signal of the first string;
the control circuit is further configured to control a direct current signal of at least one second string in the plurality of strings to be transmitted by using the second path circuit; and
the inverter circuit is configured to convert the direct current signal of the second string or the processed direct current signal of the first string into an alternating current signal.

18. The system according to claim 17, wherein the first string indicates a string whose maximum power point voltage of a corresponding direct current signal is less than a first preset voltage in the plurality of strings.

19. The system according to claim 17, wherein the first string further indicates a string whose current-voltage curve is to be detected in the plurality of strings.

20. The system according to claim 19, wherein the first path circuit comprises a first switch circuit and an MPPT circuit, and the first switch circuit comprises a plurality of first switches;
the second path circuit comprises a plurality of second switches; and
each first switch corresponds to one or more first strings and corresponds to one or more second strings, and each second switch corresponds to one or more second strings and corresponds to one or more first strings.
